(19) United States
(12) Patent Application Publication
(10) Pub. No.: US 2025/0342563 A1
(43) Pub. Date: Nov. 6, 2025

(54) IMAGE SIGNAL PROCESSOR AND IMAGE SYSTEM

(71) Applicant: Samsung Electronics Co., Ltd., Suwon-si (KR)

(72) Inventors: Changhoon Choi, Suwon-si (KR); Dusic Yoo, Suwon-si (KR); Seungwon Choi, Suwon-si (KR); Jongseong Choi, Suwon-si (KR)

(21) Appl. No.: 19/050,173

(22) Filed: Feb. 11, 2025

(30) Foreign Application Priority Data
May 3, 2024 (KR) 10-2024-0059414

(51) Int. Cl. G06T 5/20; G06T 3/40; G06T 5/70

(52) U.S. Cl. CPC G06T 5/20; G06T 3/40; G06T 5/70; G06T 2207/10024

(57) ABSTRACT

An image signal processor according to an embodiment includes a first domain including function modules configured to perform signal processing operations on a first type of image data, a second domain including function modules configured to perform signal processing operations on a second type of image data, and a dithering module configured to receive image data from a first function module of the first domain or the second domain, perform a dithering operation on the image data based on a domain type and a bit depth to result in dithered image data, and transmit the dithered image data to a second function module.

### CROSS-REFERENCE TO RELATED APPLICATION

This application is based on and claims priority under 35 U.S.C. § 119 to Korean Patent Application No. 10-2024-0059414, filed on May 3, 2024, in the Korean Intellectual Property Office, the disclosure of which is incorporated by reference herein in its entirety.

### BACKGROUND

The inventive concept relates to an image device, and more particularly, to an image signal processor and an image system.

An image sensor included in a smartphone, a tablet personal computer (PC), a digital camera, or the like acquires image information of an external object by converting light reflected from the external object into an electrical signal. Various image signal processing operations are performed to convert an electrical signal acquired from an image sensor into image information to be actually recognized by a person or enhance image quality.

An image signal processor may perform a bit reduction operation to efficiently use limited resources. The bit reduction operation may be an operation of reducing a bit depth needed for signal processing by removing or rounding off least significant bits (LSBs) of image data. Once the bit reduction operation without dithering is performed in an image processing process, distortion may occur in an image. In particular, there may occur an abnormal contour phenomenon in an image, which occurs when an image having high color-level bits is represented with lower color-level bits.

### SUMMARY

Aspects of the inventive concept provide an image signal processor and an image system that provide an enhanced image.

According to an aspect of the inventive concept, an image signal processor includes a first domain including function modules configured to perform signal processing operations on a first type of image data, a second domain including function modules configured to perform signal processing operations on a second type of image data, and a dithering module configured to receive image data from a first function module of the first domain or the second domain, perform a dithering operation on the image data based on a domain type and a bit depth to result in dithered image data, and transmit the dithered image data to a second function module.

According to another aspect of the inventive concept, an image system includes an image sensor configured to generate and output image data based on light incident from the outside the image system and an image signal processor configured to receive the image data and perform signal processing operations on the image data. The image signal processor includes a first domain corresponding to a first type and including a first function module configured to process data of a first bit depth and a second function module configured to process data of a second bit depth, a second domain corresponding to a second type and including a third function module configured to process data of a third bit depth and a fourth function module configured to process data of a fourth bit depth, and a dithering module configured to receive first image data from the first function module, perform a dithering operation on the first image data based on a domain type and a bit depth to result in first dithered image data, and transmit the first dithered image data to the second function module, and configured to receive second image data from the third function module, perform a dithering operation on the second image data based on a domain type and a bit depth to result in second dithered image data, and transmit the second dithered image data to the fourth function module.

According to another aspect of the inventive concept, an image signal processor includes a first domain including function modules configured to perform signal processing operations on a first type of image data, a second domain including function modules configured to perform signal processing operations on a second type of image data, and a dithering module configured to receive image data from a function module of the first domain or the second domain, determine a dithering scheme based on a domain type, generate noise within a bit range corresponding to a bit reduction depth, determine whether to perform dithering in a pixel based on a pixel value of the image data, and transmit dithered image data to a function module when it is determined to perform dithering in the pixel unit.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating an image system according to an embodiment;

FIG. 2A is a block diagram illustrating an image signal processor;

FIG. 2B is a detailed block diagram illustrating an image signal processor of FIG. 1 according to an embodiment;

FIG. 3 is a flowchart illustrating a method of operating the image signal processor of FIG. 1 according to an embodiment;

FIG. 4 is a detailed block diagram illustrating a dithering module of FIG. 1 according to an embodiment;

FIG. 5 is a flowchart illustrating a dithering operation of the image signal processor of FIG. 1 according to an embodiment;

FIG. 6 is a flowchart more particularly illustrating operation S210 of FIG. 5 according to an embodiment;

FIG. 7 illustrates a section check operation of the dithering module of FIG. 1 according to an embodiment;

FIG. 8 is a detailed block diagram illustrating the dithering module of FIG. 1 according to an embodiment;

FIG. 9 is a detailed block diagram illustrating a noise generator and a noise adder of FIG. 8 according to an embodiment;

FIG. 10 is a flowchart illustrating an operation of the image signal processor of FIG. 1 according to an embodiment;

FIG. 11 is a flowchart more particularly illustrating operation S330 of FIG. 10 according to an embodiment;

FIG. 12 is a detailed block diagram illustrating the image signal processor of FIG. 1 according to an embodiment;

FIGS. 13A and 13B illustrate an effect obtained by performing a dithering operation according to an embodiment; and

FIG. 14 is a block diagram illustrating an electronic device to which an image signal processor according to an embodiment is applied.

### DETAILED DESCRIPTION OF THE EMBODIMENTS

Hereinafter, embodiments are disclosed clearly and in detail enough for those of ordinary skill in the art to easily carry out the inventive concept.

Hereinafter, components described with reference to the terms, such as “ . . . er (or) or unit”, “module”, and “layer”, used in the detailed description and function blocks shown in the drawings may be implemented in the form of software, hardware, or a combination thereof. For example, the software may include machine code, firmware, embedded code, and application software. For example, the hardware may include an electrical circuit, an electronic circuit, a processor, a computer, an integrated circuit, integrated circuit cores, a pressure sensor, an inertia sensor, a microelectromechanical system (MEMS), a passive element, or a combination thereof.

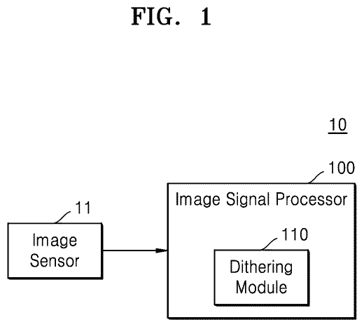

FIG. 1 is a block diagram illustrating an image system 10 according to an embodiment.

Referring to FIG. 1, the image system 10 may include an image sensor 11 and an image signal processor 100. The image system 10 may be at least one of or included in various electronic systems, such as a smartphone, a tablet personal computer (PC), a black box, and an automobile electronic device, or a digital camera, configured to acquire a video or an image of an external object, for example.

The image sensor 11 may output image data based on light incident from the outside. For example, the image sensor 11 may include a plurality of pixels. Each of the plurality of pixels may be configured to output an electrical signal corresponding to light incident from the outside. The image sensor 11 may output the image data based on the electrical signals. In an embodiment, the image data output from the image sensor 11 may include brightness information, color information, and the like of a particular frame.

The image signal processor 100 may receive the image data from the image sensor 11 and perform various signal processing operations on the received image data. For example, the image signal processor 100 may perform various signal processing operations, such as noise cancellation, white balancing, gamma correction, color correction, and color conversion, on the received image data. The signal-processed image data may be transmitted to an external device (e.g., a display device) or stored in a separate storage device. The signal-processed image data may have more enhanced image quality than the image data received from the image sensor 11.

The image signal processor 100 according to an embodiment may include a dithering module 110. The dithering module 110 may perform a dithering operation. For example, the dithering operation may be an operation of adding noise to image data to alleviate a quantization error due to a bit reduction operation. The dithering module 110 may perform the dithering operation based on a domain type DT and a bit depth BD. The dithering module 110 may generate dithering noise based on the domain type DT and the bit depth BD.

In an embodiment, the dithering module 110 may perform the dithering operation by using a dithering scheme corresponding to the domain type DT. The dithering module 110 may generate noise within a bit range corresponding to a bit depth reduced in the bit reduction operation. The dithering module 110 may selectively perform dithering in a pixel unit of the image data.

The image signal processor 100 may perform the bit reduction operation to efficiently use resources. The bit reduction operation may be an operation of reducing a bit depth needed or used for signal processing by removing or rounding off least significant bits (LSBs) of the image data.

Once the bit reduction operation without dithering is performed in an image (or video) processing process, distortion may occur in an image. In particular, there may occur an abnormal contour phenomenon in an image, which occurs when an image having high color-level bits is represented with lower color-level bits. Due to the bit reduction operation, a quantization error may occur. A contour having occurred due to a quantization error may flow along a pipeline of image signal processing, thereby causing color banding. The color banding may indicate a phenomenon in which an abnormal contour line-shaped boundary appears because a gradient region represented with continuous color levels is represented as a smoothed region with one color level due to a lowered color level (e.g., lower number of color-level bits). In particular, a contour may noticeably occur in an ultra-low luminance image.

The image signal processor 100 including the dithering module 110 according to an embodiment may alleviate this phenomenon. The dithering module 110 may randomize a quantization error by performing the dithering operation. As a result, a boundary of a portion where a contour occurs due to randomly added noise may be vague, and thus, an effect of weakening a contour phenomenon may be obtained.

The dithering module 110 may include hardware, software, or a combination thereof configured to manage the dithering operation. An operation of the dithering module 110 is described in more detail with reference to drawings below.

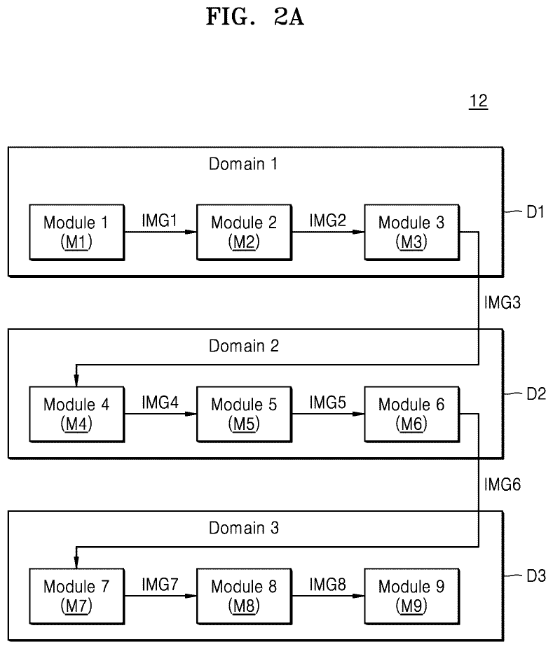

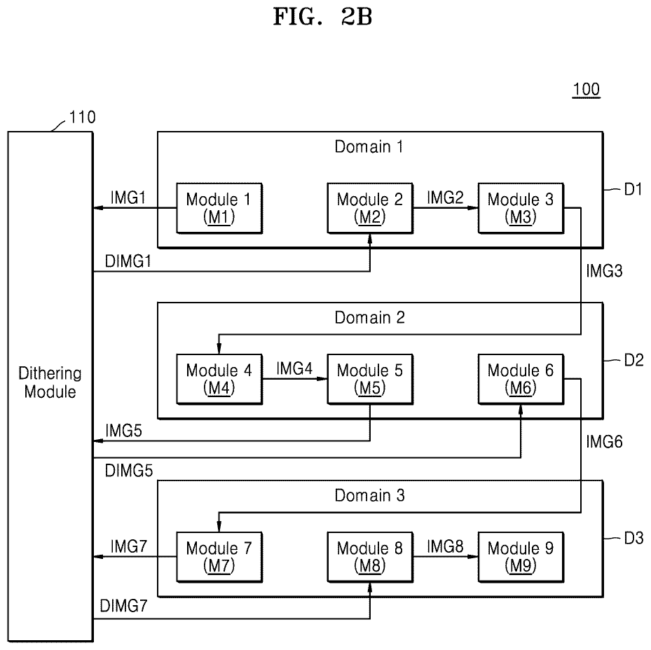

FIG. 2A is a block diagram illustrating an image signal processor 12.

Referring to FIG. 2A, the image signal processor 12 may have a pipeline structure configured to sequentially perform a plurality of signal processing operations. Image data may undergo various signal processing operations while sequentially passing through first to ninth function modules M1 to M9.

The image signal processor 12 may include first to third domains D1 to D3. The first domain D1 may include the first to third function modules M1 to M3. The second domain D2 may include the fourth to sixth function modules M4 to M6. The third domain D3 may include the seventh to ninth function modules M7 to M9. The first domain D1 may process a first type T1 of image data, the second domain D2 may process a second type T2 of image data, and the third domain D3 may process a third type T3 of image data. Each domain may include a particular set of hardware, firmware, and/or computer program code that processes a type of image data according to the function modules included therein.

The first function module M1 may receive an image from the image sensor 11 and perform a first signal processing operation on the image. The first function module M1 may output a first-signal-processed first image IMG1 to the second function module M2. The second function module M2 may perform a second signal processing operation on the first image IMG1. The second function module M2 may output a second-signal-processed second image IMG2 to the third function module M3. The third function module M3 may perform a third signal processing operation on the second image IMG2. The third function module M3 may output a third-signal-processed third image IMG3 to the fourth function module M4. The fourth function module M4 may perform a fourth signal processing operation on the third image IMG3. The fourth function module M4 may output a fourth-signal-processed fourth image IMG4 to the fifth function module M5. The other function modules (the fifth to ninth function modules M5 to M9) may operate similarly to the description above. A detailed description thereof is omitted herein.

FIG. 2B is a detailed block diagram illustrating the image signal processor 100 of FIG. 1.

Referring to FIGS. 1 and 2B, the image signal processor 100 may include the dithering module 110 and a plurality of function modules, e.g. the first to ninth function modules M1 to M9. The image signal processor 100 may include the first domain D1, the second domain D2, and the third domain D3.

The first domain D1 may include the first function module M1, the second function module M2, and the third function module M3, the second domain D2 may include the fourth function module M4, the fifth function module M5, and the sixth function module M6, and the third domain D3 may include the seventh function module M7, the eighth function module M8, and the ninth function module M9. However, the scope of the inventive concept is not limited thereto, and the number of domains and the number of function modules may increase or decrease according to implementations.

The image signal processor 100 may generate or output an image with enhanced quality by performing various kinds of image signal processing on image data received from the image sensor 11. Each of the first to ninth function modules M1 to M9 may perform a signal processing operation on image data. For example, each of the first to ninth function modules M1 to M9 may perform one or more of noise reduction, white balancing, color interpolation based on a color filter array, correction based on various factors, such as color and a gamma characteristic, an enhancement operation for enhancing image quality, such as an edge, a contrast, and a color, and the like.

In an embodiment, the first domain D1 may include function modules configured to process the first type T1 of image data. The type of the first domain D1 may be the first type T1. The second domain D2 may include function modules configured to process the second type T2 of image data. The type of the second domain D2 may be the second type T2. The third domain D3 may include function modules configured to process the third type T3 of image data. The type of the third domain D3 may be the third type T3. The image signal processor 100 may classify function modules into the first to third domains D1 to D3 according to the type (e.g., a color filter array (CFA) type) of data to be processed.

The domain type DT may indicate any one of the first to third types T1 to T3. For example, the domain type DT may indicate any one of Bayer, RGB, and YUV patterns. The first type T1 may correspond to the Bayer pattern, the second type T2 may correspond to the RGB pattern, and the third type T3 may correspond to the YUV pattern.

For example, each of the first to third domains D1 to D3 may be any one of a Bayer domain, an RGB domain, and a YUV domain. For example, the first domain D1 may be the Bayer domain, the second domain D2 may be the RGB domain, and the third domain D3 may be the YUV domain. The first domain D1 may include function modules configured to process image data of the Bayer pattern, the second domain D2 may include function modules configured to process image data of the RGB pattern, and the third domain D3 may include function modules configured to process image data of the YUV pattern. These particular domains and number of domains are only examples, and other types of domains or numbers of domains may use the dithering module 110 described herein.

An image of the Bayer pattern may be data according to the pattern (e.g., the Bayer pattern) of a CFA included in the image sensor 11. For example, a basic unit of the Bayer pattern of the CFA may include four pixels, e.g., a green color pixel Gr, a red color pixel R, a green color pixel Gb, and a blue color pixel B sequentially arranged clockwise from the upper left end of the CFA. An image of the RGB pattern indicates a data format representing colors based on the three primary colors of light. That is, an image is represented using three types of colors, such as red, green, and blue. An image of the YUV pattern indicates a data format separately representing brightness, i.e., a luma signal and a chroma signal. That is, Y indicates a luma signal, and each of U (Cb) and V (Cr) indicates a chroma signal. U indicates the component difference between the luma signal and a blue signal, and V indicates the component difference between the luma signal and a red signal. Herein, items of Y, U (Cb), and V (Cr) may be defined as planes.

The image signal processor 100 may have a pipeline structure configured to sequentially perform a plurality of signal processing operations. The image quality of image data may be enhanced while sequentially passing through the first to ninth function modules M1 to M9.

In an embodiment, the image signal processor 100 may perform the bit reduction operation. For example, the first function module M1 may process data of a first bit depth, and the second function module M2 may process data of a second bit depth that is less than the first bit depth. The image signal processor 100 may perform the bit reduction operation on data output from the first function module M1. The bit reduction operation may indicate an operation of reducing the number of bits of image data.

For example, the bit depth of the value of a pixel in the image data processed by the first function module M1 may be the first bit depth, and the bit depth of the value of a pixel in the image data processed by the second function module M2 may be the second bit depth. The image signal processor 100 may perform the bit reduction operation of reducing the bit depth of the value of a pixel of the image data from the first bit depth to the second bit depth. Due to the bit reduction operation, a quantization error may occur.

The image signal processor 12 of FIG. 2A may not include a dithering module. The image signal processor 12 may not perform the dithering operation. However, the image signal processor 100 of FIG. 2B may perform the dithering operation to prevent the occurrence of a contour phenomenon due to the bit reduction operation. The image signal processor 100 may perform the dithering operation to alleviate a quantization error.

Hereinafter, it is assumed that the bit reduction operation is performed between the first function module M1 and the second function module M2 in the first domain D1, between the fifth function module M5 and the sixth function module M6 in the second domain D2, and between the seventh function module M7 and the eighth function module M8 in the third domain D3.

The first function module M1 may process data having the first bit depth, and the second function module M2 may process data having the second bit depth that is less than the first bit depth. The fifth function module M5 may process data having a third bit depth, and the sixth function module M6 may process data having a fourth bit depth that is less than the third bit depth. The seventh function module M7 may process data having a fifth bit depth, and the eighth function module M8 may process data having a sixth bit depth that is less than the fifth bit depth. Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

According to one embodiment, the first function module M1 may receive image data from the image sensor 11. The first function module M1 may perform the first signal processing operation on the image data. The first function module M1 may output the first-signal-processed first image IMG1 to the dithering module 110. The dithering module 110 may output a first dithering image DIMG1 to the second function module M2. The second function module M2 may perform the second signal processing operation on the first dithering image DIMG1. The second function module M2 may output the second-signal-processed second image IMG2 to the third function module M3. The third function module M3 may perform the third signal processing operation on the second image IMG2. The third function module M3 may output the third-signal-processed third image IMG3 to the fourth function module M4. The third function module M3 is the last function module of the first domain D1, and thus, the third function module M3 may transmit the third image IMG3 to the second domain D2.

The fourth function module M4 may receive the third image IMG3 from the third function module M3 of the first domain D1. The fourth function module M4 may perform the fourth signal processing operation on the third image IMG3. The fourth function module M4 may output the fourth-signal-processed fourth image IMG4 to the fifth function module M5. The fifth function module M5 may perform a fifth signal processing operation on the fourth image IMG4. The fifth function module M5 may output a fifth-signal-processed fifth image IMG5 to the dithering module 110. The dithering module 110 may output a fifth dithering image DIMG5 to the sixth function module M6. The sixth function module M6 may perform a sixth signal processing operation on the fifth dithering image DIMG5. The sixth function module M6 may output a sixth-signal-processed sixth image IMG6 to the seventh function module M7. The sixth function module M6 is the last function module of the second domain D2, and thus, the sixth function module M6 may transmit the sixth image IMG6 to the third domain D3.

The seventh function module M7 may receive the sixth image IMG6 from the sixth function module M6 of the second domain D2. The seventh function module M7 may perform a seventh signal processing operation on the sixth image IMG6. The seventh function module M7 may output a seventh-signal-processed seventh image IMG7 to the dithering module 110. The dithering module 110 may output a seventh dithering image DIMG7 to the eighth function module M8. The eighth function module M8 may perform an eighth signal processing operation on the seventh dithering image DIMG7. The eighth function module M8 may output an eighth-signal-processed eighth image IMG8 to the ninth function module M9. The ninth function module M9 may perform a ninth signal processing operation on the eighth image IMG8. The ninth function module M9 may output a ninth-signal-processed image.

Limited resources may be allocated to each of the first to third domains D1 to D3. Function modules included in each of the first to third domains D1 to D3 may be arranged to efficiently perform processing within limited resources (e.g., power, a memory, and a space), and the bit depth (or the processing bits) of signal-processed data is allocated to the function modules. The bit depth of data processed by each of continuous function modules may be changed. When the bit depth of processed data is reduced, the image signal processor 100 may perform the bit reduction operation.

The image signal processor 100 according to an embodiment may perform the dithering operation together with the bit reduction operation. When the bit reduction operation is needed to perform a signal processing operation in a next function module, the image signal processor 100 may perform the dithering operation. Accordingly, unlike FIG. 2A, the first function module M1 may transmit the first image IMG1 to the dithering module 110 instead of transmitting the first image IMG1 to the second function module M2. The fifth function module M5 may transmit the fifth image IMG5 to the dithering module 110 instead of transmitting the fifth image IMG5 to the sixth function module M6. The seventh function module M7 may transmit the seventh image IMG7 to the dithering module 110 instead of transmitting the seventh image IMG7 to the eighth function module M8.

The second function module M2 may receive the first dithering image DIMG1 from the dithering module 110 instead of receiving the first image IMG1 from the first function module M1. The sixth function module M6 may receive the fifth dithering image DIMG5 from the dithering module 110 instead of receiving the fifth image IMG5 from the fifth function module M5. The eighth function module M8 may receive the seventh dithering image DIMG7 from the dithering module 110 instead of receiving the seventh image IMG7 from the seventh function module M7.

As described above, the image signal processor 100 according to an embodiment may include the first domain D1 including the first to third function modules M1 to M3 configured to perform signal processing operations on the first type T1 of image data, the second domain D2 including the fourth to sixth function modules M4 to M6 configured to perform signal processing operations on the second type T2 of image data, the third domain D3 including the seventh to ninth function modules M7 to M9 configured to perform signal processing operations on the third type T3 of image data, and the dithering module 110 configured to receive an image from a function module in the first to third domains D1 to D3, perform the dithering operation on the image based on the domain type DT and the bit depth BD, and transmit the dithered image to a function module. The dithering module 110 may be a separate module configured to receive image data from different domain types DT and to perform a dithering process with an optional bit reduction operation on any of the three domain types DT. The image signal processor 100 may perform the dithering operation before or during the bit reduction operation. Accordingly, a contour or color banding due to the bit reduction operation may be alleviated or reduced. In addition, the dithering module 110 can be easily adjusted or replaced to affect all of the different domain types DT at once.

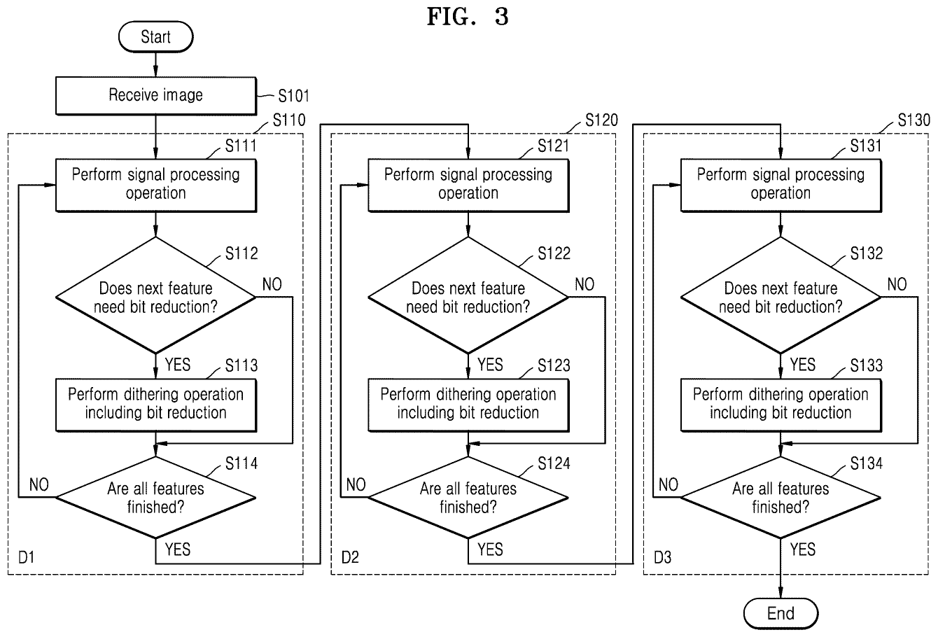

FIG. 3 is a flowchart illustrating a method of operating the image signal processor 100 of FIG. 1.

Referring to FIGS. 1, 2B, and 3, the image signal processor 100 may perform a signal processing operation. The image signal processor 100 may perform various image signal processing operations along a pipeline structure. In operation S101, the image signal processor 100 may receive image data from the image sensor 11. In operation S110, the image signal processor 100 may perform signal processing operations of the first domain D1. In operation S120, the image signal processor 100 may perform signal processing operations of the second domain D2. In operation S130, the image signal processor 100 may perform signal processing operations of the third domain D3.

Operation S110 may include operations S111 to S114, operations S120 may include operations S121 to S124, and operations S130 may include operations S131 to S134. Operations S111, S121, and S131 may be the same as or similar to each other. Operations S112, S122, and S132 may be the same as or similar to each other. Operations S113, S123, and S133 may be the same as or similar to each other. Operations S114, S124, and S134 may be the same as or similar to each other.

In operation S111, the image signal processor 100 may perform a signal processing operation corresponding to a function module. For example, when a current function module is the first function module M1, the image signal processor 100 may perform the first signal processing operation. In operation S112, the image signal processor 100 may determine whether a next function module needs the bit reduction operation. For example, when the current function module is the first function module M1, the next function module may be the second function module M2. Because the first function module M1 processes data of the first bit depth and the second function module M2 processes data of the second bit depth that is less than the first bit depth, it may be determined that the bit reduction operation is needed.

For example, when the current function module is the second function module M2, the next function module may be the third function module M3. Because the second function module M2 processes data of the second bit depth and the third function module M3 processes data of the second bit depth, it may be determined that the bit reduction operation is not needed.

The image signal processor 100 may perform operation S113 when determining that the bit reduction operation is needed, and perform operation S114 when determining that the bit reduction operation is not needed.

In operation S113, the image signal processor 100 may perform the dithering operation and a bit reduction operation. In an embodiment, the image signal processor 100 may perform the dithering operation before or during the bit reduction operation.

In an embodiment, the image signal processor 100 may perform both the bit reduction operation and the dithering operation. For example, the dithering module 110 may reduce the number of bits of data and simultaneously add noise to the data.

In operation S114, the image signal processor 100 may determine whether signal processing operations of all the function modules of the first domain D1 have been finished. For example, the image signal processor 100 may determine whether the current function module is the last function module of the first domain D1. The image signal processor 100 may perform operation S121 when the signal processing operations of all the function modules of the first domain D1 have been finished, and perform operation S111 when the signal processing operations of all the function modules of the first domain D1 have not been finished.

The image signal processor 100 may perform operation S121 when the current function module is the last function module of the first domain D1. When the current function module is not the last function module of the first domain D1, the image signal processor 100 may set the current function module as a next function module and then perform operation S111. For example, when the current function module is the first function module M1, the image signal processor 100 may set the current function module as the second function module M2 of the first domain D1 and then perform operation S111.

In operation S121, the image signal processor 100 may perform a signal processing operation corresponding to a function module of the second domain D2. In operation S122, the image signal processor 100 may determine whether a next function module of the second domain D2 needs the bit reduction operation. The image signal processor 100 may perform operation S123 when determining that the bit reduction operation is needed, and perform operation S124 when determining that the bit reduction operation is not needed. In operation S123, the image signal processor 100 may perform the dithering operation along with bit reduction. In operation S124, the image signal processor 100 may determine whether signal processing operations of all the function modules of the second domain D2 have been finished. The image signal processor 100 may perform operation S131 when the signal processing operations of all the function modules of the second domain D2 have been finished, and perform operation S121 when the signal processing operations of all the function modules of the second domain D2 have not been finished.

In operation S131, the image signal processor 100 may perform a signal processing operation corresponding to a function module of the third domain D3. In operation S132, the image signal processor 100 may determine whether a next function module of the third domain D3 needs the bit reduction operation. The image signal processor 100 may perform operation S133 when determining that the bit reduction operation is needed, and perform operation S134 when determining that the bit reduction operation is not needed. In operation S133, the image signal processor 100 may perform the dithering operation and bit reduction. In operation S134, the image signal processor 100 may determine whether signal processing operations of all the function modules of the third domain D3 have been finished. When the signal processing operations of all the function modules of the third domain D3 have not been finished, the image signal processor 100 may perform operation S131.

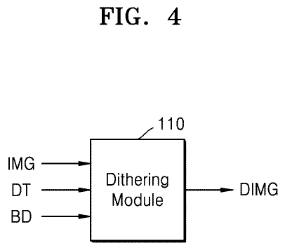

FIG. 4 is a detailed block diagram illustrating the dithering module 110 of FIG. 1.

Referring to FIGS. 1, 2B, and 4, the dithering module 110 may receive an image IMG (e.g., processed image data), the domain type DT (e.g., an indication of domain type, also described as domain type information or a domain type indicator), and the bit depth BD (e.g., an indication of a bit depth, also described as bit depth information or a bit depth indicator). The dithering module 110 may output a dithering image DIMG (e.g., image data after a dithering operation has been performed). For example, the dithering image DIMG may be an image with a reduced bit depth and added noise.

In an embodiment, the image IMG may be an image on which the bit reduction operation has been performed. For example, after a particular function module performs a signal processing operation, the data processed by the function module may have a bit reduction operation performed (e.g., by a bit reduction module of the image signal processor 100). In this case, the dithering module 110 may perform only the dithering operation. In an embodiment, the image IMG may be an image before the bit reduction operation occurs so that bit reduction is not performed prior to the image IMG being received by the dithering module 110. In this case, the dithering module 110 may perform both the bit reduction operation and the dithering operation.

The dithering module 110 may perform the dithering operation. The dithering operation may be, for example, an operation of adding noise to image data to alleviate a quantization error due to the bit reduction operation. The dithering module 110 may perform the dithering operation based on the domain type DT and the bit depth BD. For example, the bit depth BD may correspond to a reduced bit depth of the image IMG. The dithering module 110 may generate dithering noise corresponding to the domain type DT and the bit depth BD.

The dithering module 110 may be used in multiple domains. In an embodiment, the dithering module 110 may be used in all of the first to third domains D1 to D3. For example, in a signal processing process of function modules included in the first domain D1, when the bit reduction operation is performed, the dithering module 110 may perform the dithering operation on the first type T1 of data. In a signal processing process of function modules included in the second domain D2, when the bit reduction operation is performed, the dithering module 110 may perform the dithering operation on the second type T2 of data. In a signal processing process of function modules included in the third domain D3, when the bit reduction operation is performed, the dithering module 110 may perform the dithering operation on the third type T3 of data. Therefore, the dithering module 110 may perform the dithering operation on various types of image data. The dithering module 110 may perform the dithering operation by using a dithering scheme corresponding to a domain type (e.g., a different dithering scheme based on different domain types). For example, for a case in which a domain type is a CFA characteristic, the dithering module 110 may determine a dithering scheme suitable for each CFA characteristic, and may select a dithering scheme based on the type of CFA characteristic indicated in domain type information.

In an embodiment, the dithering module 110 may perform the dithering operation by using a dithering scheme corresponding to a particular domain type DT. The dithering module 110 may determine a dithering noise generation scheme and a dithering noise application scheme corresponding to the domain type DT.

In an embodiment, the dithering module 110 may generate dithering noise within a bit range corresponding to the bit depth BD. The dithering module 110 may generate dithering noise included within the same bit range as the bit depth BD.

As described above, the dithering module 110 may perform the dithering operation based on the domain type DT and the bit depth BD. Accordingly, by performing the dithering operation, the dithering module 110 may remove an abnormal contour of an image.

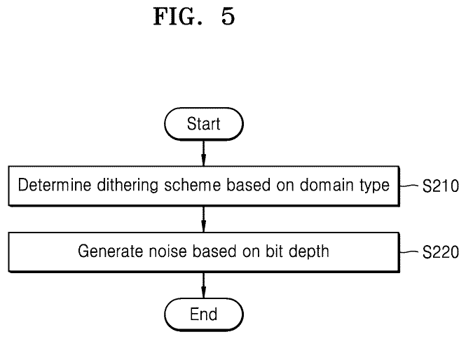

FIG. 5 is a flowchart illustrating the dithering operation of the image signal processor 100 of FIG. 1.

Referring to FIGS. 1, 3, and 5, each of operations S113, S123, and S133 of FIG. 3 may include operations S210 and S220. In operation S210, the dithering module 110 may determine a dithering scheme based on the domain type DT. The dithering module 110 may perform the dithering operation to correspond to the domain type DT. Alternatively, the dithering module 110 may perform the dithering operation by using a dithering scheme corresponding to the domain type DT. For example, when the domain type DT indicates the first type T1, the dithering module 110 may select a first dithering scheme corresponding to the first type T1 from among a plurality of dithering schemes. When the domain type DT indicates the second type T2, the dithering module 110 may select a second dithering scheme corresponding to the second type T2 from among the plurality of dithering schemes. When the domain type DT indicates the third type T3, the dithering module 110 may select a third dithering scheme corresponding to the third type T3 from among the plurality of dithering schemes.

In an embodiment, a dithering scheme may include a dithering noise generation scheme and a dithering noise application scheme. For example, the dithering noise generation scheme may be any one of a Floyd-Steinberg dithering scheme, an ordered dithering scheme, or the like. For example, the dithering noise application scheme may include a scheme of applying the same noise for each color, a scheme of applying different noise for each color, or the like.

For example, the dithering module 110 may determine a dithering noise generation scheme of the first domain D1 as the Floyd-Steinberg dithering scheme. The dithering module 110 may determine a dithering noise generation scheme of the second domain D2 as the ordered dithering scheme.

For example, when the domain type DT indicates the first type T1 (e.g., the Bayer pattern), the dithering module 110 may generate different noise for each of a green color pixel Gr, a red color pixel R, a blue color pixel B, and a green color pixel Gb. When the domain type DT indicates the second type T2 (e.g., the RGB pattern), the dithering module 110 may generate the same noise for all of a red color pixel R, a green color pixel G, and a blue color pixel B.

In operation S220, the dithering module 110 may generate dithering noise based on the bit depth BD. The dithering module 110 may perform the dithering operation based on the bit depth BD. For example, the bit depth BD may indicate a bit reduction depth. The dithering module 110 may adjust a dithering bit range according to the bit depth BD. The dithering module 110 may determine a noise range (a bit range or a dithering range) corresponding to the bit depth BD.

For example, the dithering module 110 may generate noise having a value within the same bit range as a bit reduction size. For example, in one embodiment, it is assumed that the first function module M1 of the first domain D1 processes data having the first bit depth (e.g., ‘18’) and the second function module M2 of the first domain D1 processes data having the second bit depth (e.g., ‘12’). Accordingly, the image signal processor 100 may perform the bit reduction operation of reducing the first bit depth (e.g., ‘18’) of image data to the second bit depth (e.g., ‘12’). The bit reduction size may be the difference (e.g., ‘6’) between the first bit depth and the second bit depth. The bit reduction size may be a result of a subtraction operation between the first bit depth and the second bit depth. The dithering module 110 may generate noise within a bit range corresponding to the bit reduction size. For example, the dithering module 110 may generate noise within a bit range corresponding to the difference between the first bit depth and the second bit depth.

For example, on one embodiment, it is assumed that the fifth function module M5 of the second domain D2 processes data having the third bit depth (e.g., ‘14’) and the sixth function module M6 of the second domain D2 processes data having the fourth bit depth (e.g., ‘12’). Accordingly, the bit reduction operation of reducing the third bit depth (e.g., ‘14’) of image data to the fourth bit depth (e.g., ‘12’) may be performed. The bit reduction size may be the difference (e.g., ‘2’) between the third bit depth and the fourth bit depth. The dithering module 110 may generate noise within a bit range corresponding to the bit depth difference (i.e., the bit reduction size) (e.g., ‘2’). In this example, the dithering module 110 may generate noise within a bit range corresponding to the difference between the third bit depth and the fourth bit depth.

As described above, the image signal processor 100 may perform both the bit reduction operation and the dithering operation to prevent the occurrence of a contour in an image.

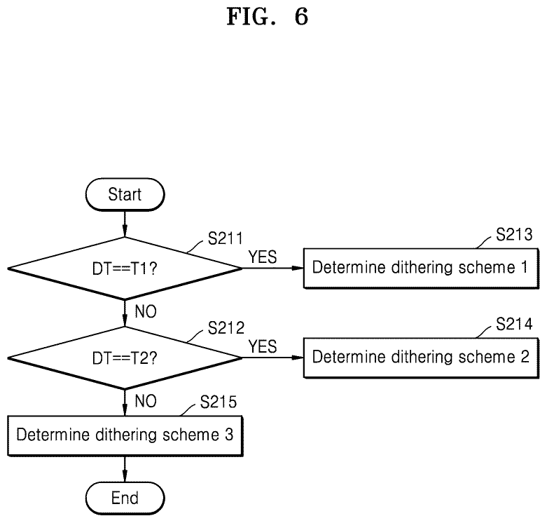

FIG. 6 is a flowchart more particularly illustrating operation S210 of FIG. 5.

Referring to FIGS. 1, 5, and 6, the dithering module 110 may perform the dithering operation based on the domain type DT and the bit depth BD. The dithering module 110 may determine a dithering noise generation scheme and a dithering noise application scheme according to a domain in which a function module is included. The dithering module 110 may perform the dithering operation by using a dithering scheme suitable for a particular domain. The dithering module 110 may perform the dithering operation by using a dithering scheme corresponding to the domain type DT.

Operation S210 may include operations S211 to S215. In operation S211, the dithering module 110 may determine whether the domain type DT is the first type T1. The dithering module 110 may perform operation S213 when the domain type DT is the first type T1, and perform operation S212 when the domain type DT is not the first type T1.

In operation S212, the dithering module 110 may determine whether the domain type DT is the second type T2. The dithering module 110 may perform operation S214 when the domain type DT is the second type T2, and perform operation S215 when the domain type DT is not the second type T2.

In operation S213, the dithering module 110 may determine and select a dithering scheme for a received image as the first dithering scheme. The dithering module 110 may select the first dithering scheme corresponding to the first type T1 from among the plurality of dithering schemes. The dithering module 110 may perform the dithering operation by using the first dithering scheme. For example, the dithering module 110 may determine the dithering scheme for the image as a first dithering noise generation scheme and a first dithering noise application scheme.

In operation S214, the dithering module 110 may determine and select the dithering scheme for the received image as the second dithering scheme. The dithering module 110 may select the second dithering scheme corresponding to the second type T2 from among the plurality of dithering schemes. The dithering module 110 may perform the dithering operation by using the second dithering scheme. For example, the dithering module 110 may determine the dithering scheme for the image as a second dithering noise generation scheme and a second dithering noise application scheme.

In operation S215, the dithering module 110 may determine and select the dithering scheme for the received image as the third dithering scheme. The dithering module 110 may select the third dithering scheme corresponding to the third type T3 from among the plurality of dithering schemes. The dithering module 110 may perform the dithering operation by using the third dithering scheme. For example, the dithering module 110 may determine the dithering scheme for the image as a third dithering noise generation scheme and a third dithering noise application scheme.

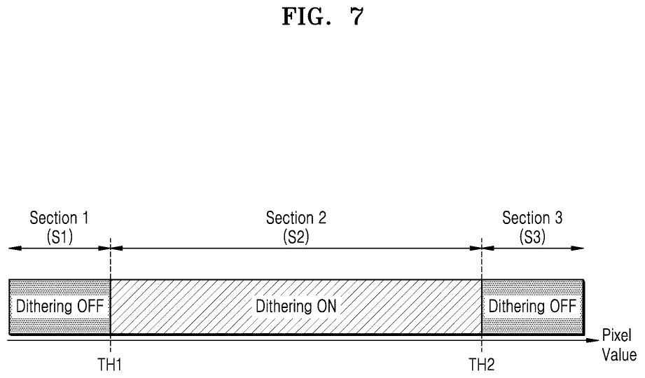

FIG. 7 illustrates a section check operation of the dithering module 110 of FIG. 1.

Referring to FIGS. 1 and 7, the dithering module 110 may selectively determine whether to perform dithering, in a pixel unit of the image IMG. The dithering module 110 may determine whether to perform dithering, based on a pixel value.

The dithering module 110 may determine whether dithering is applied in a particular section, based on a pixel value and section-specific thresholds. The dithering module 110 may determine whether to perform dithering, in a pixel unit based on a pixel value and thresholds. The pixel unit may be, for example, a single pixel, or a group of pixels that form a repeated unit, such as the basic unit of the Bayer pattern of the CFA. Where a pixel unit includes a group of pixels that form a repeated unit, a function such as averaging or other function can be used to result in a pixel value used to determine whether to perform dithering.

There may exist a particular section (e.g., a saturation region or a dark region) of a pixel value, in which side effects due to dithering may occur. For example, when negative dithering noise is added to a saturation region of an image, there may occur an unintended color artifact. To prevent distortion of an image due to dithering, the dithering module 110 may determine dithering-on/off based on the pixel value of each of pixels.

A first section S1 may indicate a section in which a pixel value is less than or equal to a first threshold TH1, a second section S2 may indicate a section in which a pixel value is greater than the first threshold TH1 and less than a second threshold TH2, and a third section S3 may indicate a section in which a pixel value is greater than or equal to the second threshold TH2. Each section may correspond to a range of pixel values. The first section S1 may be a dithering-off section, the second section S2 may be a dithering-on section, and the third section S3 may be a dithering-off section.

In an embodiment, the dithering module 110 may previously determine the first threshold TH1 and the second threshold TH2. The dithering module 110 may then perform the dithering operation only when the value of a pixel in an image is greater than the first threshold TH1 and less than the second threshold TH2. That is, the dithering module 110 may activate dithering when a pixel value belongs to the second section S2. When a pixel value is less than or equal to the first threshold TH1, the dithering module 110 may not perform the dithering operation. That is, the dithering module 110 may inactivate dithering when a pixel value belongs to the first section S1. When a pixel value is greater than or equal to the second threshold TH2, the dithering module 110 may not perform the dithering operation. That is, the dithering module 110 may inactivate dithering when a pixel value belongs to the third section S3.

As described above, the dithering module 110 may perform the dithering operation based on a pixel value. The dithering module 110 may determine whether to perform dithering, based on a pixel value. The dithering module 110 may determine dithering-on or dithering-off based on a pixel value. The dithering module 110 may activate dithering when a pixel value belongs to the second section S2. The dithering module 110 may inactivate dithering when a pixel value belongs to the first section S1 or the third section S3. Accordingly, the dithering module 110 may prevent side effects which may occur, by performing dithering in a particular section of a pixel value.

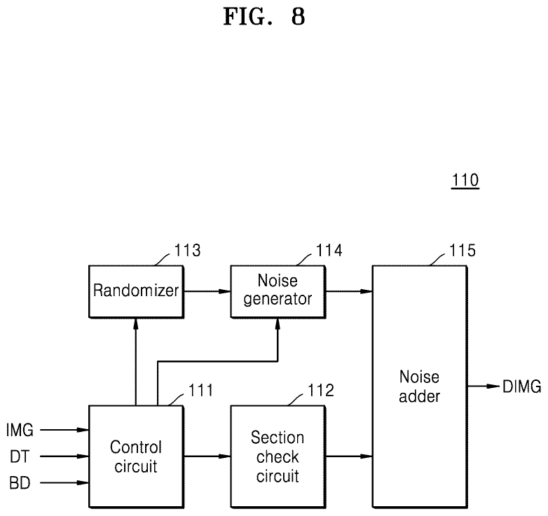

FIG. 8 is a detailed block diagram illustrating the dithering module 110 of FIG. 1.

Referring to FIGS. 1 and 8, the dithering module 110 may include a control circuit 111, a section check circuit 112, a randomizer 113, a noise generator 114, and a noise adder 115. The dithering module 110 may determine a dithering scheme based on the domain type DT. The dithering module 110 may generate noise within a bit range corresponding to the bit depth BD. The dithering module 110 may selectively perform dithering in a pixel unit of image data.

The control circuit 111 may control a general operation of the dithering module 110. The control circuit 111 may receive the image IMG, the domain type DT, and the bit depth BD. The control circuit 111 may determine a dithering scheme based on the domain type DT. The control circuit 111 may determine a dithering noise generation scheme and a dithering noise application scheme corresponding to the domain type DT. The control circuit 111 may determine the bit range of dithering noise based on the bit depth BD. The control circuit 111 may output a control signal to the randomizer 113, the noise generator 114, and the section check circuit 112.

The randomizer 113 may operate under control by the control circuit 111. The randomizer 113 may receive an initial seed value. For example, the randomizer 113 may receive the initial seed value from an external processor. The randomizer 113 may generate a random number (or a random value) based on the initial seed value. The randomizer 113 may output the generated random number to the noise generator 114. The randomizer 113 may receive a feedback signal from the noise generator 114. The randomizer 113 may generate a random number based on the feedback signal. For example, the randomizer 113 may be a linear feedback shift register (LFSR).

The noise generator 114 may operate in response to a control signal of the control circuit 111. The noise generator 114 may receive a random number from the randomizer 113. The noise generator 114 may generate noise based on the random number and the control signal. The noise generator 114 may generate noise according to a dithering scheme determined by the control circuit 111. The noise generator 114 may generate noise within the bit range of dithering noise, which is determined by the control circuit 111.

The section check circuit 112 may determine whether to perform dithering, based on the value of a pixel in the image IMG. The section check circuit 112, also described as a range check circuit, may determine whether the values of the pixels in the image IMG are included in a dithering-on section. The section check circuit 112 may determine whether the pixel value of each of pixels belongs to any one of a dithering-on section or a dithering-off section, to determine, in a pixel unit, whether to perform dithering. The section check circuit 112 may generate mask data corresponding to the pixels in the image IMG. For example, when the image IMG includes 16 pixels arranged as 4×4, the mask data may be 4×4 matrix data. The mask data may include a plurality of mask values, one assigned to each pixel. Each of the plurality of mask values may be a first value (e.g., ‘0’) or a second value (e.g., ‘1’).

When a mask value is the first value, the dithering module 110 may perform dithering on a pixel corresponding to the mask value. When a mask value is the second value, the dithering module 110 may not perform dithering on a pixel corresponding to the mask value.

In an embodiment, when the value of a pixel in the image IMG belongs to the dithering-on section, the section check circuit 112 may set a mask value corresponding to the pixel as the first value. When the value of a pixel in the image IMG belongs to the dithering-off section, the section check circuit 112 may set a mask value corresponding to the pixel as the second value.

When the value of a pixel belongs to the first section S1 (i.e., the dithering-off section), a mask value of the mask data corresponding to the pixel may be the second value. When the value of a pixel belongs to the second section S2 (i.e., the dithering-on section), a mask value of the mask data corresponding to the pixel may be the first value. When the value of a pixel belongs to the third section S3 (i.e., the dithering-off section), a mask value of the mask data corresponding to the pixel may be the second value.

The noise adder 115 may add noise to the image IMG. The noise adder 115 may receive noise from the noise generator 114. The noise adder 115 may receive the mask data from the section check circuit 112. The noise adder 115 may add noise to the image IMG based on the mask data.

In an embodiment, when a mask value of the mask data indicates the first value, the noise adder 115 may add noise to a corresponding pixel. When a mask value of the mask data indicates the second value, the noise adder 115 may not add noise to a corresponding pixel. Based on the mask data, dithering-on or dithering-off may be performed in a pixel or pixel unit. The noise adder 115 may output the dithering image DIMG.

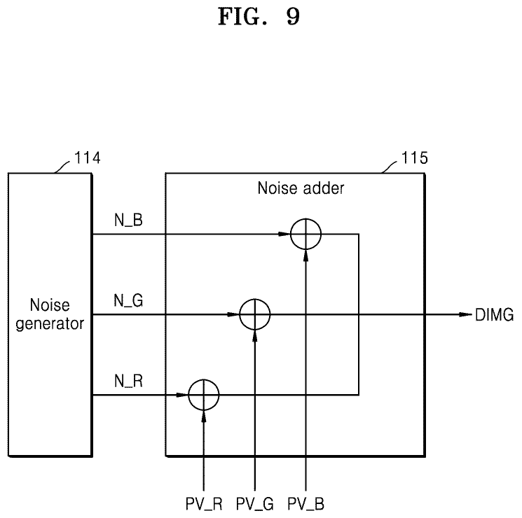

FIG. 9 is a detailed block diagram illustrating the noise generator 114 and the noise adder 115 of FIG. 8.

Referring to FIGS. 1, 8, and 9, in this example, it is assumed that the domain type DT received by the dithering module 110 is the second type T2 (e.g., the RGB pattern). The control circuit 111 may determine a dithering scheme based on the domain type DT. Because the domain type DT is the second type T2, the control circuit 111 may determine a dithering noise application scheme as a scheme of applying different noise for each color.

Accordingly, the noise generator 114 may generate red noise N_R corresponding to a red color R, green noise N_G corresponding to a green color G, and blue noise N_B corresponding to a blue color B. The noise generator 114 may generate the red noise N_R, the green noise N_G, and the blue noise N_B that are different from each other. The noise generator 114 may output the red noise N_R, the green noise N_G, and the blue noise N_B to the noise adder 115.

The noise adder 115 may add the red noise N_R to a red pixel value PV_R, add the green noise N_G to a green pixel value PV_G, and add the blue noise N_B to a blue pixel value PV_B. The noise adder 115 may output the dithering image DIMG that is a noise-added image.

For example, the dithering module 110 may execute pseudo code as shown in Table 1. Table 1 shows an example of pseudo code for the dithering operation.

TABLE 1

PN_seed = random seed;
new_PN_seed = updated random seed by LSFR
LSFR_bitdepth = LSFR bit depth = 12 (4 x 3 = 4 bit x rgb);
pixel_value[R/G/B] = Pixel value R/G/B
12 bit LSFR operation for random seed update:
val_0 = (PN_seed > > 0) & 1; // 12
val_1 = (PN_seed >> 3) & 1; // 9
val_2 = (PN_seed >> 4) & 1; // 8
val_3 = (PN_seed >> 7) & 1; // 5
new_PN_seed = ( (1 << LSFR_bitdepth - 1) ) * (val_0 ? val_1 ? val_2 ? val_3) + (PN_seed
>> 1);
Apply 4-bit dither noise on R/G/B pixel:
pixel_value[R] += PN_seed & 0x00f
pixel_value[G] += (PN_seed & 0x0f0) >> 4
pixel_value[B] += (PN_seed & 0xf00) >> 8
where >>, &, \hat{ } is bitwise operator of right shifter, AND, and XOR.

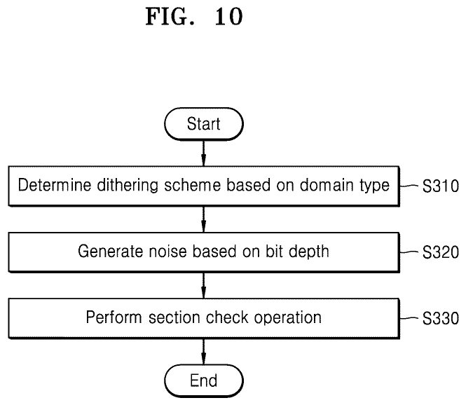

FIG. 10 is a flowchart illustrating an operation of the image signal processor 100 of FIG. 1. Referring to FIGS. 1, 5, and 10, the image signal processor 100 may perform the dithering operation together with the bit reduction operation. The image signal processor 100 may perform operations S310 to S330. Because operations S310 and S320 are similar to operations S210 and S220 of FIG. 5, a detailed description thereof is omitted herein.

In operation S310, the image signal processor 100 may determine a dithering scheme based on the domain type DT. In operation S320, the image signal processor 100 may generate noise based on the bit depth BD.

In operation 330, the image signal processor 100 may perform the section check operation. The section confirmation operation may be an operation of determining whether the value of a pixel in an image is included in a dithering-on section. The image signal processor 100 may perform the section confirmation operation to selectively perform dithering-on or dithering-off for each pixel.

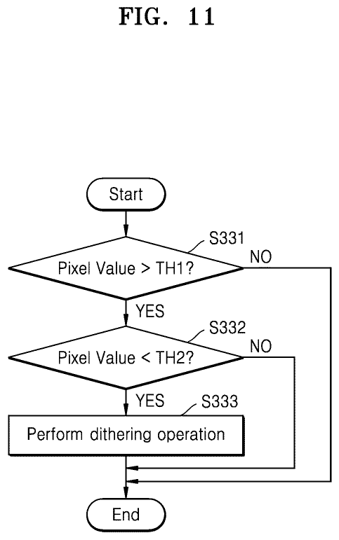

FIG. 11 is a flowchart more particularly illustrating operation S330 of FIG. 10.

Referring to FIGS. 1, 10, and 11, operation S330 of FIG. 10 may include operations S331 to S333. The dithering module 110 may perform dithering in a pixel based on a pixel value. The dithering module 110 may not perform the dithering operation when the value of a pixel in image data is less than or equal to the first threshold TH1, may not perform the dithering operation when the value of a pixel in the image data is greater than or equal to the second threshold TH2, and may perform the dithering operation when the value of a pixel in the image data is greater than the first threshold TH1 and less than the second threshold TH2.

In operation S331, the dithering module 110 determines whether a pixel value is greater than the first threshold TH1. The dithering module 110 may perform operation S332 when the pixel value is greater than the first threshold TH1, and may not perform the dithering operation when the pixel value is less than or equal to the first threshold TH1.

For example, when the pixel value is less than or equal to the first threshold TH1, the pixel value may belong to the first section S1 (i.e., a dithering-off section). When it is determined that the pixel value belongs to the first section S1, the dithering module 110 may perform dithering-off for a corresponding pixel. That is, the dithering module 110 may not add noise to the corresponding pixel.

In operation S332, the dithering module 110 determines whether the pixel value is less than the second threshold TH2. The dithering module 110 may perform operation S333 when the pixel value is less than the second threshold TH2, and may not perform the dithering operation when the pixel value is greater than or equal to the second threshold TH2.

For example, when the pixel value is greater than or equal to the second threshold TH2, the pixel value may belong to the third section S3 (i.e., a dithering-off section). When it is determined that the pixel value belongs to the third section S3, the dithering module 110 may perform dithering-off for the corresponding pixel. That is, the dithering module 110 may not add noise to the corresponding pixel.

In operation S333, the dithering module 110 performs the dithering operation. The dithering module 110 may add noise to the corresponding pixel. For example, when the pixel value is greater than the first threshold TH1 and less than the second threshold TH2, the pixel value may belong to the second section S2 (i.e., a dithering-on section). When it is determined that the pixel value belongs to the second section S2, the dithering module 110 may perform dithering-on for the corresponding pixel. That is, the dithering module 110 may add noise to the corresponding pixel.

As described above, the dithering module 110 may perform the dithering operation only when the value of a pixel in an image belongs to a dithering-on section. The dithering module 110 may selectively perform dithering in a pixel or pixel unit. Accordingly, the image signal processor 100 may provide an enhanced image.

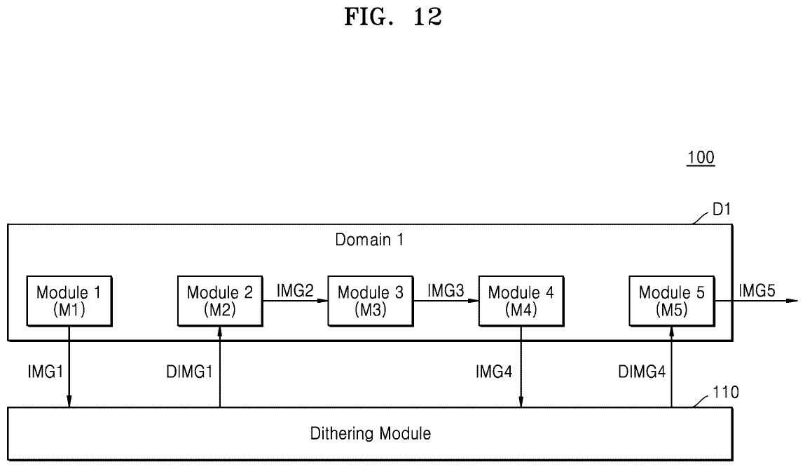

FIG. 12 is a detailed block diagram illustrating the image signal processor 100 of FIG. 1.

Referring to FIGS. 1, 2B, and 12, the image signal processor 100 may include the dithering module 110 and a plurality of domains. For conciseness of drawing and convenience of description, FIG. 12 shows only the first domain D1. The image signal processor 100 may further include a second domain (not shown) and a third domain (not shown). For example, the first domain D1 may include the first to fifth function modules M1 to M5.

The first function module M1 may process data having the first bit depth. The second function module M2 may process data having the second bit depth that is less than the first bit depth. The third function module M3 may process data having the second bit depth. The fourth function module M4 may process data having the second bit depth. The fifth function module M5 may process data having the third bit depth that is less than the second bit depth.

The image signal processor 100 may perform the bit reduction operation and the dithering operation between the first function module M1 and the second function module M2. The image signal processor 100 may perform the bit reduction operation and the dithering operation between the fourth function module M4 and the fifth function module M5.

The first function module M1 may receive image data from the image sensor 11. The first function module M1 may perform the first signal processing operation on the image data. The first function module M1 may output the first-signal-processed first image IMG1 to the dithering module 110. The dithering module 110 may output the first dithering image DIMG1 to the second function module M2. The second function module M2 may perform the second signal processing operation on the first dithering image DIMG1. The second function module M2 may output the second-signal-processed second image IMG2 to the third function module M3. The third function module M3 may perform the third signal processing operation on the second image IMG2. The third function module M3 may output the third-signal-processed third image IMG3 to the fourth function module M4.

The fourth function module M4 may perform the fourth signal processing operation on the third image IMG3. The fourth function module M4 may output a fourth-signal-processed fourth image IMG4 to the dithering module 110. The dithering module 110 may output a fourth dithering image DIMG4 to the fifth function module M5. The fifth function module M5 may perform the fifth signal processing operation on the fourth dithering image DIMG4. The fifth function module M5 may output a fifth-signal-processed fifth image IMG5.

Compared to FIG. 2B, in FIG. 12, the image signal processor 100 may perform the bit reduction operation and the dithering operation two or more times in the same domain (i.e., the first domain D1). The image signal processor 100 may perform the dithering operation a plurality of times in the same domain. For example, the dithering module 110 may perform the dithering operation on the first image IMG1 output from the first function module M1 and generate and output the first dithering image DIMG1. For example, the first image IMG1 may be image data that has the first bit depth, such that both dithering and bit reduction is performed by the dithering module 110 on the first image IMG1, or the first image IMG1 may be image data that has already been reduced in bit depth to a second bit depth after exiting the first function module M1 and before being transmitted to the dithering module 110. The dithering module 110 may perform the dithering operation on the fourth image IMG4 output from the fourth function module M4 and generate and output the fourth dithering image DIMG4. For example, the fourth image IMG4 may be image data that has the second bit depth, such that both dithering and bit reduction is performed by the dithering module 110 on the fourth image IMG4, or the fourth image IMG4 may be image data that has already been reduced in bit depth after exiting the fourth function module M4 and before being transmitted to the dithering module 110.

Because both the first image IMG1 and the fourth image IMG4 are output from function modules included in the first domain D1, the dithering module 110 may determine a dithering scheme for an image as the same dithering scheme. The dithering module 110 may receive the first image IMG1 and the domain type DT indicating the first type T1. The dithering module 110 may determine a dithering scheme corresponding to the first type T1. The dithering module 110 may receive the fourth image IMG4 and the domain type DT indicating the first type T1. The dithering module 110 may determine a dithering scheme corresponding to the first type T1. For example, the same dithering scheme may be used for the first image IMG1 and the fourth image IMG4. However, because a bit depth (i.e., the difference between the first bit depth and the second bit depth) for the first image IMG1 is different from a bit depth (i.e., the difference between the second bit depth and the third bit depth) for the fourth image IMG4, the dithering module 110 may add a different size of noise.

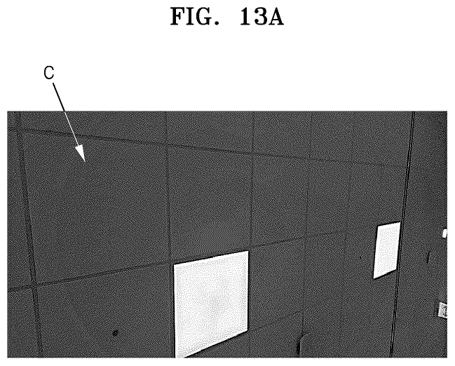

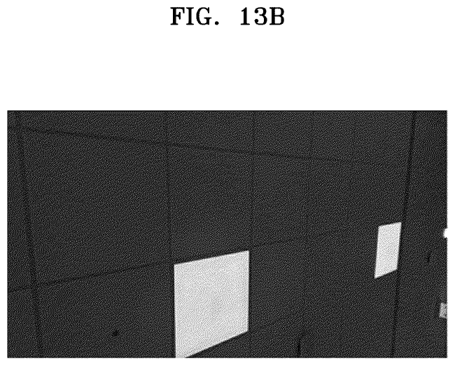

FIGS. 13A and 13B illustrate an effect obtained by performing the dithering operation according to an embodiment.

FIG. 13A illustrates a final image on which the dithering operation has not been performed, and FIG. 13B illustrates a final image on which the dithering operation has been performed. Referring to FIG. 13A, a contour C occurs because the dithering operation is not performed. In particular, ultra-low luminance domain color banding occurs. Referring to FIG. 13B, by performing the dithering operation, a contour occurring phenomenon or a color banding occurring phenomenon may be alleviated or reduced.

The image signal processor 100 may perform the dithering operation based on a domain type and a bit depth and perform dithering-on or dithering-off in a pixel or pixel unit based on a pixel value. Accordingly, a contour or color banding may not occur in a low luminance domain, and the image signal processor 100 may provide an enhanced image.

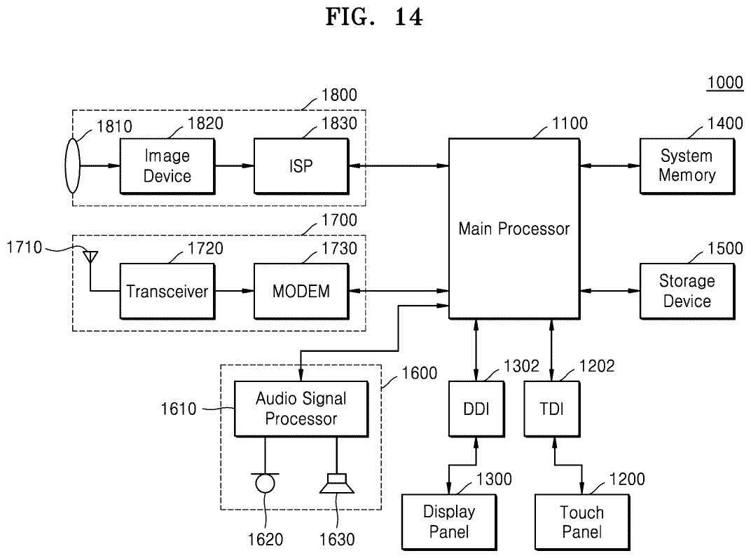

FIG. 14 is a block diagram illustrating an electronic device 1000 to which an image signal processor 1830 according to an embodiment is applied.

Referring to FIG. 14, the electronic device 1000 may include a main processor 1100, a touch panel 1200, a touch driving circuit 1202, a display panel 1300, a display driving circuit 1302, a system memory 1400, a storage device 1500, an audio processor 1600, a communication block 1700, and the image processor 1800. In an embodiment, the electronic device 1000 may be one of various electronic devices, such as a mobile communication terminal, a personal digital assistant (PDA), a portable media player (PMP), a digital camera, a smartphone, a tablet computer, a laptop computer, and a wearable device.

The touch driving circuit 1202 may control the touch panel 1200. The touch panel 1200 may sense a touch input from a user, under control by the touch driving circuit 1202. The display driving circuit 1302 may control the display panel 1300. The display panel 1300 may display image information under control by the display driving circuit 1302.

The system memory 1400 may store data to be used for an operation of the electronic device 1000. For example, the system memory 1400 may temporarily store data processed or to be processed by the main processor 1100. For example, the system memory 1400 may include a volatile memory, such as static random access memory (SRAM), dynamic RAM (DRAM), synchronous DRAM (SDRAM), and/or a nonvolatile memory, such as phase-change RAM (PRAM), magnetoresistive RAM (MRAM), resistive RAM (ReRAM), ferroelectric RAM (FRAM). In an embodiment, output data output from the image signal processor 1830 may be stored in the system memory 1400.

The storage device 1500 may store data regardless of power supply. For example, the storage device 1500 may include at least one of various nonvolatile memories, such as flash memory, PRAM, MRAM, ReRAM, and FRAM. For example, the storage device 1500 may include an embedded memory of the electronic device 1000 and/or a detachable memory.

The image processor 1800 may receive light through a lens 1810. An image device 1820 and the image signal processor 1830 included in the image processor 1800 may generate image information regarding an external object based on the received light. In an embodiment, the image signal processor 1830 may be the image signal processor 100 described with reference to FIGS. 1 to 12 or operate based on the method described with reference to FIGS. 1 to 12.

In an embodiment, the main processor 1100 may include the image signal processor 100 described with reference to FIGS. 1 to 12 or operate based on the method described with reference to FIGS. 1 to 12.

The communication block 1700 may exchange signals with an external device/system through an antenna 1710. A transceiver 1720 and a modulator/demodulator (MODEM) 1730 of the communication block 1700 may exchange signals with an external device/system according to at least one of various wireless communication standards, such as long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processor 1600 may process an audio signal by using an audio signal processor 1610. The audio processor 1600 may receive an audio input through a microphone 1620 or provide an audio output through a speaker 1630.

The main processor 1100 may control a general operation of the electronic device 1000. The main processor 1100 may control/manage operations of components of the electronic device 1000. The main processor 1100 may process various computations to operate the electronic device 1000. The main processor 1100 may execute one or more instructions of a program or a plurality of neural network models stored in a memory. The main processor 1100 according to an embodiment may be a central processing unit (CPU) but is not limited thereto and may include an application processor (AP), a graphics processing unit (GPU), or the like.

In an embodiment, some of the components of FIG. 14 may be implemented in the form of system-on-chip and provided as an AP of the electronic device 1000.

While the inventive concept has been particularly shown and described with reference to embodiments thereof, it will be understood that various changes in form and details may be made therein without departing from the spirit and scope of the following claims.

What is claimed is:

1. An image signal processor comprising:
a first domain comprising function modules configured to perform signal processing operations on a first type of image data;
a second domain comprising function modules configured to perform signal processing operations on a second type of image data; and
a dithering module configured to receive image data from a first function module of the first domain or the second domain, perform a dithering operation on the image data based on a domain type and a bit depth to result in dithered image data, and transmit the dithered image data to a second function module.

2. The image signal processor of claim 1, wherein the dithering module is further configured to receive image data, a domain type indicator, and a bit depth indicator from a function module of the first domain or the second domain, the domain type indicator indicating either the first type or the second type, and the bit depth indicator indicates a bit reduction depth.

3. The image signal processor of claim 2, wherein the dithering module is further configured to determine a dithering scheme based on the domain type indicated by the domain type indicator and generate noise based on the bit depth indicated by the bit depth indicator.

4. The image signal processor of claim 2, wherein the dithering module is further configured to determine a dithering noise generation scheme and a dithering noise application scheme based on the domain type indicated by the domain type indicator.

5. The image signal processor of claim 4, wherein the dithering noise generation scheme includes either a Floyd-Steinberg dithering scheme or an ordered dithering scheme.

6. The image signal processor of claim 1, wherein the dithering module is further configured to perform the dithering operation based on a pixel value of the image data.

7. The image signal processor of claim 1, wherein the dithering module is further configured to perform the dithering operation only when a pixel value of the image data belongs to a dithering-on section.

8. The image signal processor of claim 1, wherein the dithering module is further configured not to perform the dithering operation when a pixel value of the image data is less than or equal to a first threshold, not to perform the dithering operation when the pixel value of the image data is greater than or equal to a second threshold, and to perform the dithering operation when the pixel value of the image data is greater than the first threshold and less than the second threshold.

9. The image signal processor of claim 1, wherein the dithering module comprises:
a control circuit configured to receive the image data, a domain type indicator indicating the domain type, and a bit depth indicator indicating the bit depth, determine a dithering scheme based on the domain type indicated by the domain type indicator, and determine a bit range of dithering noise based on the bit depth indicated by the bit depth indicator;
a randomizer configured to generate a random number;
a noise generator configured to generate noise based on the random number received from the randomizer and a control signal received from the control circuit;
a section check circuit configured to determine whether to perform dithering, based on a pixel value of the image data; and
a noise adder configured to receive mask data from the section check circuit, receive the noise from the noise generator, and add the noise to the image data based on the mask data.

10. The image signal processor of claim 1, wherein the dithering operation is performed before or during a bit reduction operation.

11. The image signal processor of claim 1, wherein the dithering module is further configured to determine whether to perform dithering in a pixel based on a pixel value of the image data.

12. An image system comprising:
an image sensor configured to generate and output image data based on light incident from outside the image system; and
an image signal processor configured to receive the image data and perform signal processing operations on the image data,
wherein the image signal processor comprises:
a first domain corresponding to a first type and comprising a first function module configured to process data of a first bit depth and a second function module configured to process data of a second bit depth;
a second domain corresponding to a second type and comprising a third function module configured to process data of a third bit depth and a fourth function module configured to process data of a fourth bit depth; and
a dithering module configured to receive first image data from the first function module, perform a dithering operation on the first image data based on a domain type and a bit depth to result in first dithered image data, and transmit the first dithered image data to the second function module, and configured to receive second image data from the third function module, perform a dithering operation on the second image data based on a domain type and a bit depth to result in second dithered image data, and transmit the second dithered image data to the fourth function module.

13. The image system of claim 12, wherein the dithering module is further configured to perform the dithering operation by using a first dithering scheme corresponding to the first type when receiving the first image data from a function module of the first domain, and perform the dithering operation by using a second dithering scheme corresponding to the second type when receiving the second image data from a function module of the second domain.

14. The image system of claim 12, wherein the dithering module is further configured to generate noise within a bit range corresponding to a difference between the first bit depth and the second bit depth when receiving the first image data from the first function module, and generate noise within a bit range corresponding to a difference between the third bit depth and the fourth bit depth when receiving the second image data from the third function module.

15. The image system of claim 12, wherein the dithering module is further configured to determine whether to perform dithering, in a pixel based on a pixel value of the image data.

16. The image system of claim 12, wherein the dithering module is further configured to perform dithering when a pixel value of the image data belongs to a dithering-on section, and not to perform dithering when the pixel value of the image data belongs to a dithering-off section.

17. The image system of claim 12, wherein the dithering module comprises:
a control circuit configured to receive the image data, the domain type, and the bit depth, determine a dithering scheme based on the domain type, and determine a bit range of dithering noise based on the bit depth;
a randomizer configured to generate a random number;
a noise generator configured to generate noise based on the random number received from the randomizer and a control signal received from the control circuit;
a section check circuit configured to determine whether to perform dithering, based on a pixel value of the image data; and
a noise adder configured to receive mask data from the section check circuit, receive the noise from the noise generator, and add the noise to the image data based on the mask data.

18. An image signal processor comprising:
a first domain comprising function modules configured to perform signal processing operations on a first type of image data;
a second domain comprising function modules configured to perform signal processing operations on a second type of image data; and
a dithering module configured to receive image data from a function module of each of the first domain and the second domain, determine a dithering scheme based on a domain type, generate noise within a bit range corresponding to a bit reduction depth, determine whether to perform dithering in a pixel based on a pixel value of the image data, and transmit dithered image data to another function module when it is determined to perform dithering in the pixel.

19. The image signal processor of claim 18, wherein the dithering module comprises:
a control circuit configured to receive the image data, the domain type, and a bit depth, determine the dithering scheme based on the domain type, and determine a bit range of dithering noise based on the bit depth;
a randomizer configured to generate a random number;
a noise generator configured to generate noise based on the random number received from the randomizer and a control signal received from the control circuit;
a section check circuit configured to determine whether to perform dithering, based on the pixel value of the image data; and
a noise adder configured to receive mask data from the section check circuit, receive the noise from the noise generator, and add the noise to the image data based on the mask data.

20. The image signal processor of claim 18, wherein the dithering module is further configured to perform dithering when the pixel value of the image data belongs to a dithering-on section, and not to perform dithering when the pixel value of the image data belongs to a dithering-off section.
